(19) United States
(12) Patent Application Publication
(10) Pub. No.: US 2017/0111445 A1
(43) Pub. Date: Apr. 20, 2017

(54) METHODS AND SYSTEMS FOR COMPUTATIONAL RESOURCE ALLOCATION

(71) Applicant: XEROX CORPORATION, Norwalk, CT (US)

(72) Inventors: Shruti Kunde, Mumbai (IN); Tridib Mukherjee, Bangalore (IN); Varun Sharma, Kolkata (IN); Priyanka Harish, Mysor (IN)

(21) Appl. No.: 14/886,123

(22) Filed: Oct. 19, 2015

(51) Int. Cl. H04L 29/08; H04L 12/919; H04L 12/927

(52) U.S. Cl. CPC H04L 67/1014; H04L 47/80; H04L 47/765

(57) ABSTRACT

Methods and systems for computational resource allocation in a distributed computing environment are disclosed. A request for computational resource allocation is received at a first computational node. The request comprises at least a threshold value of an expected reliability associated with a set of required computational resources. The availability of one or more computational resources from the set of required computational resources is determined at the first computational node. Based on the determined availability of the one or more computational resources, a first reliability score of the first computational node is determined. Further, the first reliability score is compared with the threshold value of expected reliability. Based on the comparison, the one or more computational resources are allocated to process the request.

### TECHNICAL FIELD

The presently disclosed embodiments are related, in general, to a distributed computing environment. More particularly, the presently disclosed embodiments are related to methods and systems for computational resource allocation in the distributed computing environment.

### BACKGROUND

Distributed computing refers to a computing network in which one or more interconnected computing devices may communicate with each other by sharing one or more computational resources (e.g., instances of CPU's, RAM, disk-space and the like). One of the types of distributed computing may be volunteer computing in which one or more computer owners may voluntarily donate the one or more computational resources associated with the respective one or more computing devices. For example, the one or more computer owners can help process certain applications, which require high levels of processing powers and memory usage by sharing the one or more computational resources owned by the respective one or more computer owners.

Generally, in a volunteer computing network, one or more requestors may transmit a request for allocation of the one or more computational resources (e.g., for executing the workload/applications) to one or more computational resource providers. The one or more computational resource providers may allocate the one or more computational resources associated with the respective one or more computational resource providers.

In certain scenarios, a computational resource provider may not be able to completely fulfill, the requirement of the one or more computational resources requested by the one or more requestors. For example, the one or more computational resources available with the computational resource provider may partially fulfill the request of the one or more requestors. Additionally, a reliability associated with the computational resource provider may not satisfy an expected reliability of the one or more requestors. In such scenario, the allocation of the one or more computational resources requested by the one or more requestors becomes a challenge.

Further limitations and disadvantages of conventional and traditional approaches will become apparent to those of skilled in the art, through a comparison of described systems with some aspects of the present disclosure, as set forth in the remainder of the present application and with reference to the drawings.

### SUMMARY

According to the embodiments illustrated herein, there may be provided a method for computational resource allocation in a distributed computing environment. The method includes receiving, by a first computational node, a request for computational resource allocation. The request comprises at least a threshold value of an expected reliability associated with a set of required computational resources. The method further includes determining, by the first computational node, an availability of one or more computational resources from the set of required computational resources. The method further includes determining, by the first computational node, a first reliability score of the first computational node based on the one or more determined computational resources. The method further includes comparing, by the first computational node, the first reliability score with the threshold value. The method further includes transmitting, by the first computational node, the request to a second computational node based on the comparison.

According to the embodiments illustrated herein, there may be provided another method for computational resource allocation in a distributed computing environment. The method includes receiving, by a first computational node, a request for computational resource allocation. The request comprises at least a threshold value of an expected reliability associated with a set of required computational resources, and a first reliability score of a second computational node. The request is received from the second computational node. The method further includes determining, by the first computational node, an availability of the set of required computational resources. The method further includes determining, by the first computational node, a second reliability score of the first computational node based on the determined set of required computational resources. The method further includes determining, by the first computational node, a third reliability score based on the first reliability score and the second reliability score. The method further includes comparing, by the first computational node, the third reliability score with the threshold value. The method further includes allocating, by the first computational node, the set of required computational resources to process the request, based on the comparison.

According to the embodiments illustrated herein, there may be provided a system for computational resource allocation in a distributed computing environment. The system includes one or more processors of a first computational node configured to receive a request for computational resource allocation. The request comprises at least a threshold value of an expected reliability associated with a set of required computational resources. The one or more processors of the first computational node are further configured to determine an availability of one or more computational resources from the set of required computational resources. The one or more processors of the first computational node are further configured to determine a first reliability score of the first computational node based on the one or more determined computational resources. The one or more processors of the first computational node are further configured to compare the first reliability score with the threshold value. The one or more processors of the first computational node are further configured to transmit the request to a second computational node based on the comparison.

According to the embodiments illustrated herein, there may be provided another system for computational resource allocation in a distributed computing environment. The system includes one or more processors of a first computational node configured to receive a request for computational resource allocation. The request comprises at least a threshold value of an expected reliability associated with a set of required computational resources, and a first reliability score of a second computational node. The request is received from the second computational node. The one or more processors of the first computational node are further configured to determine an availability of the set of required computational resources. The one or more processors of the first computational node are further configured to determine a second reliability score of the first computational node based on the determined set of required computational resources. The one or more processors of the first computational node are further configured to determine a third reliability score based on the first reliability score and the second reliability score. The one or more processors of the first computational node are further configured to compare the third reliability score with the threshold value. The one or more processors of the first computational node are further configured to allocate the set of required computational resources to process the request, based on the comparison.

According to the embodiments illustrated herein, there may be provided a non-transitory computer-readable storage medium having stored thereon, a set of computer-executable instructions for causing a computer comprising one or more processors associated with a first computational node to perform steps comprises receiving, by a first computational node, a request for computational resource allocation. The request comprises at least a threshold value of an expected reliability associated with a set of required computational resources. The one or more processors may further determine an availability of one or more computational resources from the set of required computational resources. The one or more processors may further determine a first reliability score of the first computational node based on the one or more determined computational resources. The one or more processors may further compare the first reliability score with the threshold value. The one or more processors may further transmit the request to a second computational node based on the comparison.

According to embodiments illustrated herein, there is provided another non-transitory computer-readable storage medium having stored thereon, a set of computer-executable instructions for causing a computer comprising one or more processors associated with a first computational node to perform steps comprises receiving, by a first computational node, a request for computational resource allocation. The request comprises at least a threshold value of an expected reliability associated with a set of required computational resources, and a first reliability score of a second computational node. The request is received from the second computational node. The one or more processors may further determine an availability of the set of required computational resources. The one or more processors may further determine a second reliability score of the first computational node based on the determined set of required computational resources. The one or more processors may further determine a third reliability score based on the first reliability score and the second reliability score. The one or more processors may further compare the third reliability score with the threshold value. The one or more processors may further allocate the set of required computational resources to process the request, based on the comparison.

### BRIEF DESCRIPTION OF DRAWINGS

The accompanying drawings illustrate various embodiments of systems, methods, and other aspects of the disclosure. Any person with ordinary skill in the art would appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram that illustrates a system environment in which various embodiments of a method and a system may be implemented, in accordance with at least one embodiment;

FIGS. 2A and 2B are block diagrams that illustrate an interaction between one or more computational nodes and one or more computing devices, in accordance with at least one embodiment;

FIG. 3 is a block diagram that illustrates components of a computational node, such as a first computational node 104a, in accordance with at least one embodiment;

FIG. 4 is a flowchart that illustrates a method for the allocation of a set of required computational resources, in accordance with at least one embodiment;

FIG. 5 is a flowchart that illustrates another method for the allocation of the set of required computational resources, in accordance with at least one embodiment; and

FIG. 6 is a block diagram that illustrates an example scenario for the allocation of the set of required computational resources, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definition: The following terms shall have, for the purposes of this application, the respective meanings set forth below.

A “computing device” refers to a device that includes a processor/microcontroller and/or any other electronic component, or a device or a system that performs one or more operations according to one or more programming instructions. Examples of the computing device include, but are not limited to, a desktop computer, a laptop, a personal digital assistant (PDA), a mobile phone, a smart-phone, a tablet computer, and the like. In an embodiment, one or more computing devices correspond to one or more requestors and/or one or more computational resource providers.

“Computational resources” refer to resources associated with one or more computing devices, required for executing an application/workload. The computational resources correspond to, but are not limited to, a processing speed, a storage space, a memory space, a software application, a security service, and/or a database service. For example, computational resources required by a computing device to execute an application may include <400 MHz CPU, 2 GB RAM>.

An “enterprise infrastructure” refers to an aggregation of one or more computing devices installed or used at a predetermined location. For instance, an office infrastructure comprises the one or more computing devices that are connected to each other over a communication network. The one or more computing devices may further be connected to a central server. In an embodiment, the central server maintains information of the one or more computational resources associated with the one or more computing devices. Additionally, the central server maintains information of the available one or more computational resources. Further, the central server allocates the one or more available computational resources to other such office infrastructures. Such an office infrastructure may correspond to the enterprise infrastructure.

A “computational node” refers to a physical server in a communication network. In an embodiment, plurality of computational nodes is interconnected with each other via the communication network. Each of the plurality of computational nodes represents a computing device. For example, the computational node may correspond to a central server in an enterprise infrastructure. The computational node transmits a request, for a set of required computational resources, to other computational nodes in the communication network. In an embodiment, the computational node maintains information pertaining to one or more computational resources associated with each of one or more computing devices represented by the computational node. Further, the computational node maintains and updates a reliability score, while executing received applications/workloads by using the one or more computational resources associated with the computational node. In an embodiment, the computational node maintains and updates a first reliability score when a set of required computational resources is partially available at the computational node. In an embodiment, the computational node maintains and updates a second reliability score when the set of required computational resources is completely available at the computational node. In an embodiment, based on the first reliability score and/or the second reliability score, the computational node allocates one or more available computational resources to the request.

“Reliability” refers to a measure of trust/guarantee on execution of a process/an application using one or more computational resources allocated by a computational node. In an embodiment, reliability may correspond to a first reliability score, a second reliability score and a third reliability score. The first reliability score may correspond to a level of trust/guarantee score on execution of a process/an application using one or more computational resources partially allocated by a computational node. In an embodiment, the first reliability score is defined as a ratio of number of times a request is partially processed by a computational node and total number of requests processed by the computational node. In an embodiment, the second reliability score may correspond to a level of trust/guarantee score on execution of a process/an application using one or more computational resources completely allocated by a computational node. In an embodiment, the second reliability score is defined as a ratio of number of times a request is completely processed by a computational node and total number of requests processed by the computational node. In an embodiment, the third reliability score may correspond to a level of trust/guarantee score of a path of the communication network to process the request. The path may correspond to a communication network route that connects one or more computational nodes that together fulfill the requirement of the request.

“Requestor” refers to at least one computing device in an enterprise infrastructure that requires a set of required computational resources. In an embodiment, the at least one computing device in the enterprise infrastructure transmits a request for the set of required computational resources to a computational node representing the enterprise infrastructure. In an embodiment, the requestor requires the set of required computational resources to execute the applications/workloads. In an embodiment, the requestor corresponds to the computing device that is not connected to the enterprise infrastructure. Such a requestor may forward the request of the set of required computational resources to one or more computational nodes in a communication network.

A “threshold value of expected reliability” refers to a measure of trust/guarantee that is expected on execution of a process/an application by using one or more computational resources. In an embodiment, the requestor may define the threshold value of expected reliability.

A “set of required computational resources” refers to computational resources required to process a request from a requestor. In an embodiment, the set of computational resources is required to process the request based on a threshold value of expected reliability associated with the request. The terminologies “set of required computational resources” and “set of computational resources” are used interchangeably in the disclosure herein.

A “request” refers to a message that may correspond to a requirement for a set of computational resources. The computing device in the enterprise infrastructure may transmit the request to a computational node representing the enterprise infrastructure. In an embodiment, the request comprises information pertaining to the set of required computational resources. Further, the request includes a threshold value of expected reliability associated with the set of required computational resources.

“One or more available computational resources” refer to one or more computational resources that is associated with one or more computational nodes and may be utilized to process a request from a requestor. The terminologies “one or more available computational resources” and “one or more computational resources” are used interchangeably in the disclosure herein.

A “virtual machine (VM)” refers to a software that emulates a physical computing environment on a computing device upon which an operating system (OS) or program can be installed and run. The virtual machines may be installed upon a virtualization platform, such as a hypervisor that manages the virtual machine and handles communication between the virtual machine and the underlying physical hardware of the computing devices. In an embodiment, the requestors may request for the computational resources from the providers in the form of the virtual machines (VMs). For example, a collection of, central processing unit (CPU) of the capacity 100 MHz, 1 GB RAM, and a disk space of 20 GB may constitute one virtual machine.

A “notification” refers to a message generated by a computational node from one or more computational nodes when a set of required computational resources matches with one or more available computational resources associated with the computational node from the one or more computational nodes. In an embodiment, the notification informs a requestor that the set of required computational resources have been allocated. In an embodiment, the notification is generated based on a comparison of a threshold value of expected reliability associated with the request received from the requestor. with a first reliability score and/or a third reliability score.

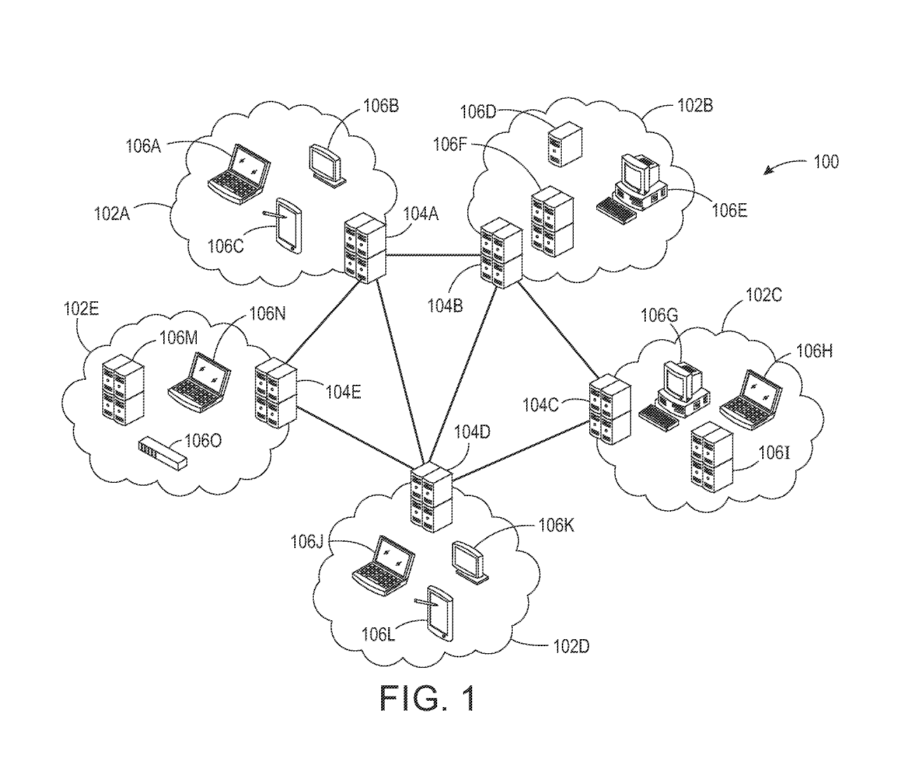

FIG. 1 is a block diagram that illustrates a system environment 100 in which various embodiments of a method and a system may be implemented, in accordance with at least one embodiment. The system environment 100 includes one or more enterprise infrastructures 102a-102e (hereinafter collectively referred to as enterprise infrastructures 102), one or more computational nodes 104a-104e (hereinafter collectively referred to as one or more computational nodes 104), and one or more computing devices 106a-106o (hereinafter collectively referred to as the one or more computing devices 106). In an embodiment, each of the one or more enterprise infrastructures 102 (e.g., the enterprise infrastructure 102a) may be represented by a computational node (e.g., the first computational node 104a). Further, the computational node from the one or more computational nodes that represent the enterprise infrastructure may be configured to store information pertaining to the one or more computing devices associated with the enterprise infrastructure. For example, the first computational node 104a in the enterprise infrastructure 102a may be configured to store information pertaining to the one or more computing devices, such as 106a, 106b, and 106c. Further, the one or more computational nodes 104 may be interconnected with each other over a communication network (not depicted in FIG. 1).

The one or more enterprise infrastructures 102 may refer to an aggregation of the one or more computing devices 106. For example, as depicted in FIG. 1, the enterprise infrastructure 102a includes the computing devices 106a-106c. In an embodiment, the one or more computing devices 106 may be aggregated based on one or more factors such as a geographical location, a type of the computing device, and a communication network to which the one or more computing devices may be connected. For example, the one or more computing devices 106 in an organization in a particular geographical location may constitute the enterprise infrastructure 102a. In a similar way, in the organization, different one or more physical servers may be aggregated to form the enterprise infrastructure 102a, whereas one or more laptops or desktop computers may be aggregated to form the enterprise infrastructure 102b.

The one or more computational nodes 104 may refer to one or more physical servers that represent the respective enterprise infrastructures 102. In an embodiment, the one or more computational nodes 104 may refer to a computing device or a software framework hosting an application or a software service. In an embodiment, the one or more computational nodes 104 may be implemented to execute procedures such as, but not limited to, programs, routines, or scripts stored in one or more memories for supporting the hosted application or the software service. In an embodiment, the hosted application or the software service may be configured to perform one or more predetermined operations. In an embodiment, the one or more computational nodes 104 may be realized through various types of servers such as, but not limited to, Java server, .NET framework, and Base4 server. Examples of such one or more computational nodes may be denoted by 104a, 104b, 104c, 104d, and 104e.

The one or more computing devices 106 may correspond to the computing devices that have associated one or more computational resources. As discussed above, the one or more computing devices 106 are aggregated to form an enterprise infrastructure (e.g., the enterprise infrastructure 102a). Each of the one or more computing devices 106 may comprise one or more processors and one or more memories. The one or more memories may include computer readable code that may be executable by the one or more processors to perform predetermined operations. Examples of the one or more computing devices 106 may include, but are not limited to, a personal computer, a laptop, a personal digital assistant (PDA), a mobile device, a tablet, or any other computing device. Examples of such one or more computing devices 106 may be denoted by 106a-106o.

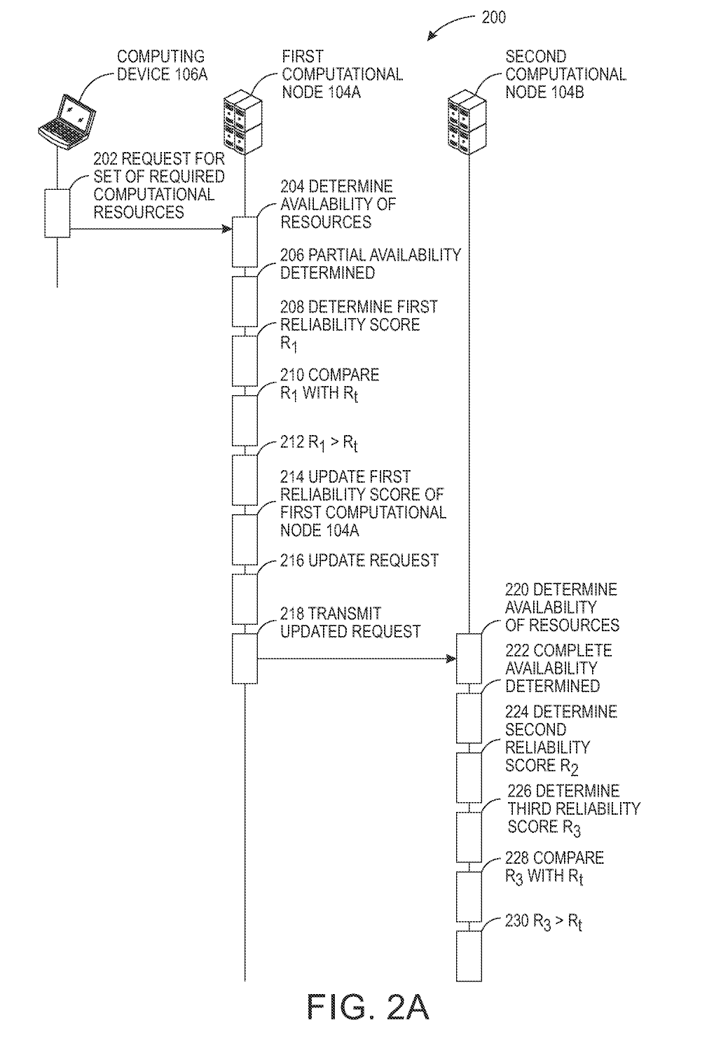

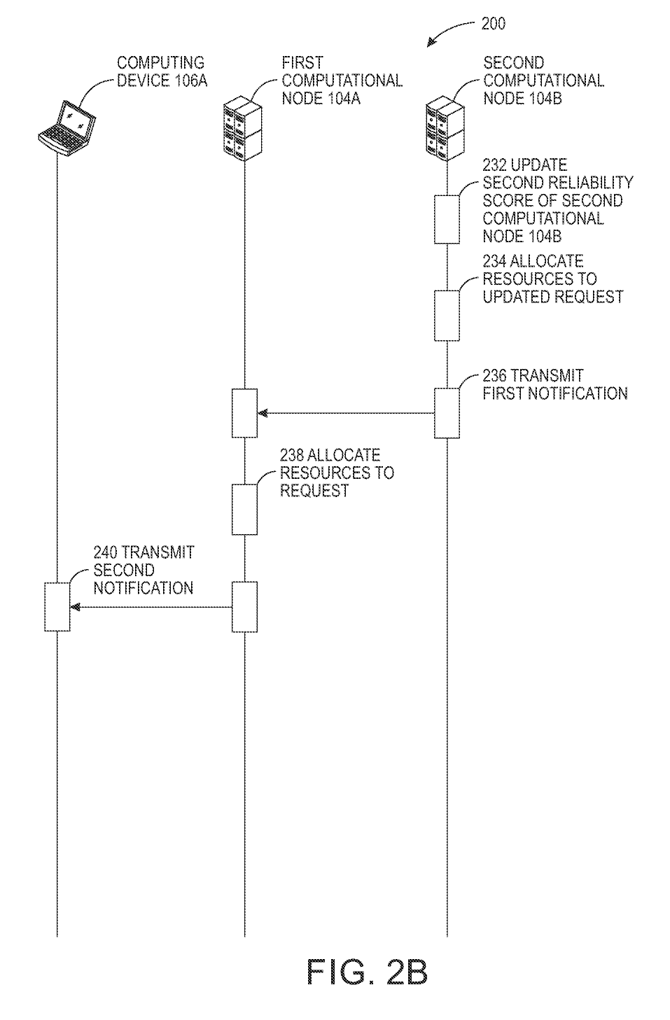

FIGS. 2A and 2B are a block diagram 200 that illustrates an interaction between the one or more computational nodes 104 and the one or more computing devices 106, in accordance with at least one embodiment. FIGS. 2A and 2B are explained in conjunction with the elements described in FIG. 1.

During the interaction denoted by 202, a first computational node 104a may be configured to receive a request for allocation of a set of required computational resources from a computing device 106a. In an embodiment, the request may comprise the set of required computational resources and a threshold value of expected reliability associated with the request.

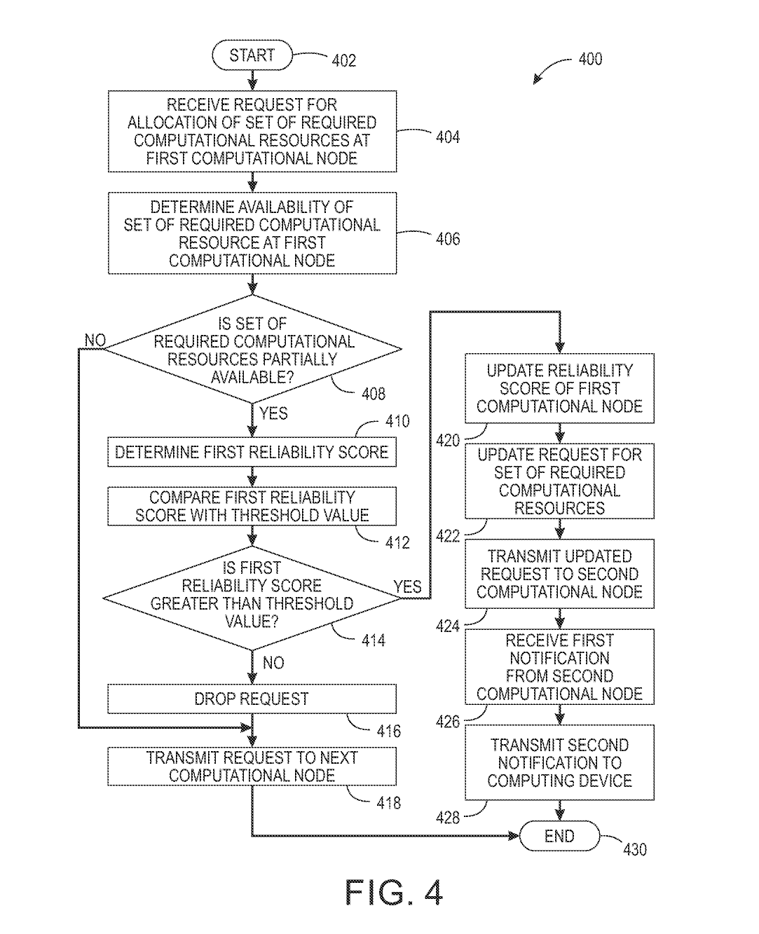

During the interaction denoted by 204, the first computational node 104a may be configured to determine one or more available computational resources to process the request. In an embodiment, the first computational node 104a may maintain a repository of one or more available computational resources. In an embodiment, the first computational node 104a may receive the information pertaining to one or more available computational resources from the one or more computing devices 106 associated with the first computational node 104a. In an embodiment, the first computational node 104a may determine if the set of required computational resources is partially available or completely available at the first computational node 104a based on the one or more available computational resources. In an embodiment, during the interaction denoted by 206, it may be determined by the first computational node 104a that the set of required computational resources are partially available at the first computational node 104a. The determination of the availability of the one or more computational resources has been explained later in detail in conjunction with FIG. 4.

After partial availability is determined, during the interaction denoted by 208, the first reliability score (R₁) may be determined based on a ratio of number of times the request is partially processed by the first computational node 104a and total number of requests processed by the first computational node 104a. The determination of the first reliability score has been explained later in detail in conjunction with FIG. 4.

Subsequently, during the interaction denoted by 210, the first computational node 104a may compare the first reliability score with the threshold value of expected reliability (Rₜ). During the interaction denoted by 212, the first computational node may determine that the first reliability score is higher than the threshold value of expected reliability. Thus, if the first reliability score is higher than the threshold value of expected reliability, during the interaction denoted by 214, the first computational node 104a may update the first reliability score associated with the first computational node 104a. After updating the first reliability score, the first computational node 104a may update the request and transmit the updated request to the second computational node 104b.

Further, if the first reliability score is less than the threshold value of expected reliability, then the request for the set of required computational resources may be transmitted to a second computational node 104b. A person with ordinary skill in the art will understand that the second computational node 104b may be configured to perform the operations similar to that of the first computational node 104a.

After updating the information pertaining to the reliability associated with the first computational node 104a, during the interaction denoted by 216, the first computational node 104a may update the request that is originally received by the computing device 106a of the first computational node 104a. In an embodiment, the updated request includes the updated computational resources, the first reliability score, and the threshold value of expected reliability. Subsequently, during the interaction denoted by 218, the first computational node 104a may transmit the updated request to the second computational node 104b. In response to the updated request received by the second computational node 104b, during the interaction denoted by 220, the second computational node 104b, may be configured to determine the availability of the set of required computational resources of the updated request at the second computational node 104b.

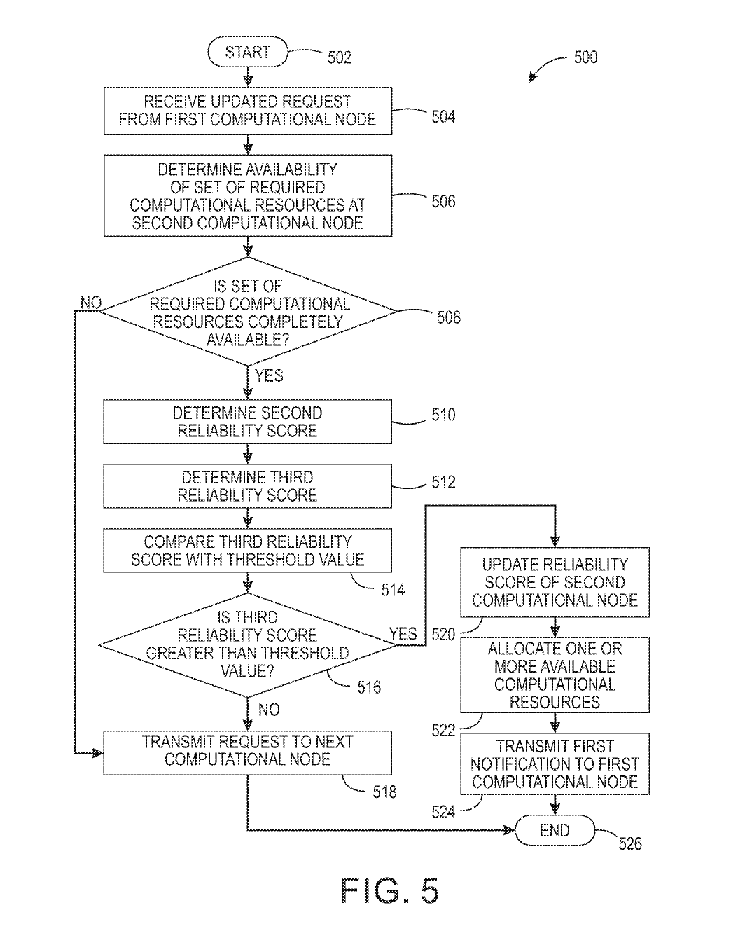

After determination of the one or more available resources at the second computational node 104b, during the interaction denoted by 222, the second computational node 104b may determine that the set of required computational resources in the updated request are completely available at the second computational node 104b. Subsequently, during the interaction denoted by 224, the second computational node 104b may determine a second reliability score (R₂). In an embodiment, the second reliability score may be determined based on a ratio of number of times the request is completely processed by the second computational node 104b and total number of requests processed by the second computational node 104b. The determination of the second reliability score has been explained later in detail in conjunction with FIG. 5.

After determination of the second reliability score, during the interaction denoted by 226, the second computational node 104b may be configured to determine a third reliability score (R₃) that indicates a reliability score that correspond to a level of trust/guarantee score of a path of the communication network to process the request. The path may correspond to a communication network route that connects one or more computational nodes that together fulfill the requirement of the request. In an embodiment, the third reliability score may be determined based on a reliability score (first reliability score and second reliability score) of each of the computational nodes from the one or more computational nodes (first computational node 104a and second computational node 104b) that may contribute to process the request. The determination of the third reliability score has been explained later in detail in conjunction with FIG. 5.

During the interaction denoted by 228, the second computational node 104b may be configured to compare the third reliability score with the threshold value of expected reliability. During the interaction denoted by 230, it may be determined that the third reliability score is higher than the threshold value of expected reliability. Subsequently, during the interaction denoted by 232, the second computational node 104b may update the second reliability score associated with the second computational node 104b. In an embodiment, if the third reliability score is lesser than the threshold value of expected reliability, then the updated request for the set of required computational resources may be transmitted to a third computational node 104c.

After updating the reliability associated with the second computational node 104b, during the interaction denoted by 234, the second computational node 104b may allocate the one or more available computational resources associated with the second computational node 104b to process the updated request. Further, during the interaction denoted by 236, the second computational node 104b may transmit a first notification to the first computational node 104a. The first notification may inform the first computational node 104a that the one or more available computational resources associated with the second computational node 104b have been allocated to process the updated request. In response to the first notification received, during the interaction denoted by 238, the first computational node 104a may allocate the one or more available computational resources associated with the first computational node 104a to process the request.

After allocation of the one or more available computational resources associated with the first computational node 104a to process the request, during the interaction denoted by 240, the first computational node 104a may transmit a second notification to the computing device 106a. In an embodiment, the second notification may inform the computing device 106a that the one or more available computational resources associated with the first computational node 104a, and the second computational node 104b have been allocated to process the request for the set of required computational resources.

It will be apparent to a person skilled in the art that various devices in the system environment 100, as disclosed above, may be interconnected via the communication network. The communication network may correspond to a communication medium through which the one or more computational nodes 104 and the one or more computing devices 106 may communicate with each other. Such a communication may be performed, in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The communication network may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

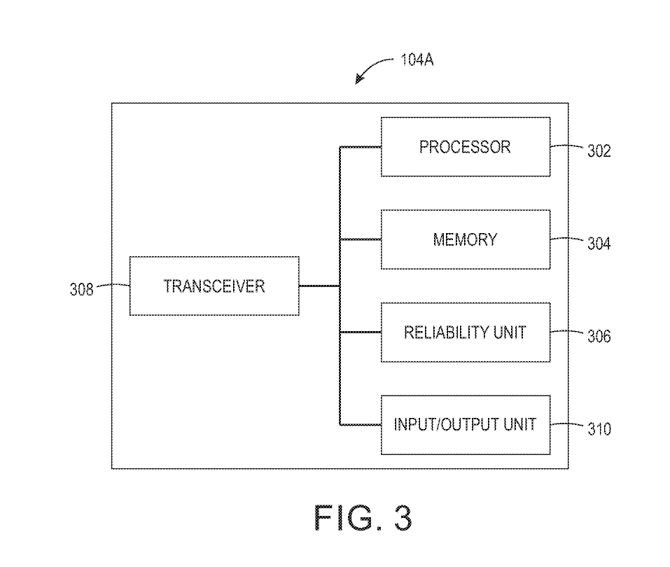

FIG. 3 is a block diagram that illustrates components in the computational node such as the first computational node 104a, in accordance with at least one embodiment. FIG. 3 is explained in conjunction with the elements from FIG. 1, and FIG. 2.

The first computational node 104a includes a processor 302, a memory 304, a reliability unit 306, a transceiver 308, and an input/output unit 310. A person with ordinary skill in the art will appreciate that the scope of the disclosure is not limited to the components as described herein. Further, in an embodiment, the first computational node 104a may correspond to any of the one or more computational nodes 104.

The processor 302 may comprise suitable logic, circuitry, interfaces, and/or code that may be configured to execute a set of instructions stored in the memory 304. The processor 302 may be implemented based on a number of processor technologies known in the art. The processor 302 may work in coordination with the reliability unit 306, the transceiver 308, and the input/output unit 310, to process the request for computational resource allocation. Examples of the processor 302 include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

The memory 304 may comprise suitable logic, circuitry, and/or interfaces that are configured to store a set of instructions and data. In an embodiment, the memory 304 may be configured to store one or more programs, routines, or scripts that may be executed in coordination with the processor 302. Some of the commonly known memory implementations include, but are not limited to, a random access memory (RAM), a read only memory (ROM), a hard disk drive (HDD), and a secure digital (SD) card. It will be apparent to a person having ordinary skill in the art that the one or more instructions stored in the memory 304 enables the hardware of the first computational node 104a to perform the predetermined operation.

The reliability unit 306 may include suitable logic, circuitry, and/or interfaces that may be configured to determine the first reliability score, and/or the second reliability score of the computational node based on the received request for the set of required computational resources and the one or more available computational resources associated with the computational node. In an embodiment, the third reliability score may be determined by the reliability unit 306. Further, the reliability unit 306 may further be configured to update the information pertaining to the reliability score based on the allocation of the one or more available computational resources. In an embodiment, the reliability unit 306 may be implemented as an Application-Specific Integrated Circuit (ASIC) microchip designed for a special application, such as to determine the first reliability score, the second reliability score, and the third reliability score.

The transceiver 308 may comprise suitable logic, circuitry, interfaces, and/or code that may be configured to receive the request for computational resource allocation, via the communication network. The transceiver 308 may be further configured to transmit and receive the first and/or second notification from one or computational nodes 104, via the communication network. The transceiver 308 may implement one or more known technologies to support wired or wireless communication with the communication network. In an embodiment, the transceiver 308 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 308 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The input/output unit 310 comprises suitable logic, circuitry, interfaces, and/or code that may be configured to receive an input or provide an output to a user. The input/output unit 310 comprises various input and output devices that are configured to communicate with the processor 302. Examples of the input devices include, but are not limited to, a keyboard, a mouse, a joystick, a touch screen, a microphone, a camera, and/or a docking station. Examples of the output devices include, but are not limited to, a display screen and/or a speaker.

The operation of each of the units described above has been explained later in conjunction to FIG. 4 and FIG. 5.

FIG. 4 is a flowchart 400 that illustrates a method for allocation of the set of required computational resources, in accordance with at least one embodiment. For the purpose of ongoing disclosure, the method for allocation of the set of required computational resources is implemented on the first computational node 104a. However, a person having ordinary skill in the art would understand that the scope of the disclosure is not limited to allocation of the set of required computational resources by the first computational node 104a. In an embodiment, the method may be implemented on any of the computational node among the one or more computational nodes 104. The flowchart 400 is described in conjunction with FIG. 1, FIG. 2, and FIG. 3.

The method begins at step 402 and proceeds to step 404. At step 404, a request for allocation of the set of computational resources may be received at the first computational node 104a, from the computing device 106a. The processor 302 of the first computational node 104a may receive the request that may comprise the set of required computational resources. The request may further comprise the threshold value of expected reliability associated with the set of required computational resources. For example, a request for the set of required computational resources may contain a CPU of the capacity “300 MHz” and a memory with “5 GB RAM” and the threshold value of expected reliability is “0.65”.

In an embodiment, the request at the first computational node 104a may be received in the form of a tuple as shown below.

R={C₁,C₂},Rₜ) (1)

where,

R=request for the set of required computational resources,

C₁ and C₂=capacity of the computational resource,

Rₜ=threshold value of expected reliability associated with the set of required computational resources.

A person skilled in the art will understand that the scope of the disclosure should not be limited to the representation of the received request using the aforementioned techniques. Further, the examples provided in supra are for illustrative purposes and should not be construed to limit the scope of the disclosure. In another embodiment, the request may be in the form of an array, a table, or a linked list, and the like.

For example, Table 1, provided below, illustrates a request that comprises a set of required computational resources and the threshold value of expected reliability associated with the set of required computational resources, received at the first computational node 104a.

TABLE 1
Illustration of the request received
at the first computational node 104a.

| | Set of required | Threshold value of |
|---|---|---|
| Request | computational resources | expected reliability |
| Request - 1 | 300 MHz CPU, 5 GB RAM | 0.65 |

At step 406, the processor 302 of the first computational node 104a may determine the availability of the set of required computational resources. The processor 302 may determine the availability of the set of required computational resources by matching the set of required computational resources with the one or more available computational resources associated with the first computational node 104a. In an embodiment, the one or more available computational resources associated with the first computational node 104a are depicted in below provided Table 2:

TABLE 2
Illustration of one or more available computational resources
associated with the first computational node 104a.

| First computational | One or more available |
|---|---|
| node 104a | computational resources |
| Computing device 1 | 100 MHz CPU, 3 GB RAM |

It will be apparent to a person having ordinary skill in the art that the above Table 2 has been provided only for illustration purposes and should not limit the scope of the invention to these types of request only. For example, the one or more available computational resources included in the Table 2 may be different from the depicted one or more available computational resources and may include more or less computational resources than depicted in Table 2.

At step 408, the processor 302 may determine, whether the set of required computational resources partially matches with the one or more available computational resources. For example, from Table 2 it can be observed that the first computational node 104a has one or more available computational resources, such as, “100 MHz” and “3 GB RAM”. The request as depicted in Table 1 has a set of required computational resources, such as, “300 MHz CPU” and “5 GB RAM”. Thus, the first computational node 104a may partially fulfill the requirement of the request. If the processor 302 determines that the set of required computational resources are partially available at the first computational node 104a, then the method proceeds to step 410 is performed, else the method proceeds to step 418.

At step 410, the reliability unit 306 may determine the first reliability score of the first computational node 104a. In an embodiment, the first reliability score may be determined based on a ratio of number of times a request is partially processed by the first computational node 104a and total number of requests processed by the first computational node 104a.

In an embodiment, the reliability unit 306 may determine the first reliability score in accordance with the below equation (2).

$${R}_{1} = \frac{{N}_{p}}{{T}_{s}} \qquad ( 2 )$$

where,

R₁=first reliability score of the first computational node 104a,

Nₚ=number of times a request is partially processed by the first computational node 104a,

Tₛ=total number of requests processed by the first computational node 104a.

A person skilled in the art will understand that the scope of the disclosure should not be limited to the representation of the determination of the first reliability score using the aforementioned techniques. Further, the examples provided in supra are for illustrative purposes and should not be construed to limit the scope of the disclosure.

For example, the first computational node 104a may receive plurality of requests for computational resource allocation. In an instance, “Ts=100” denotes the total number of requests processed by the first computational node 104a. In another instance, “Np=90” denotes the number of times a request is partially processed by the first computational node 104a. Thus, the first reliability score such as, “R₁=0.90”, may be determined by utilizing the equation (2).

At step 412, the processor 302 may compare the first reliability score R₁ of the first computational node 104a with the threshold value of expected reliability associated with the set of required computational resources of the request. At step 414, the processor may determine whether the first reliability score, R₁ of the first computational node 104a is higher than the threshold value of expected reliability associated with the set of required computational resources of the request. When the first reliability score R₁ of the first computational node 104a is higher than the threshold value of expected reliability associated with the set of required computational resources of the request, the method proceeds to step 420, else the method proceeds to step 416.

At step 416, the processor 302 may drop the request, as the first reliability score R₁ of the first computational node 104a is lower than the threshold value of expected reliability associated with the set of required computational resources of the request. After the request for the allocation of the set of computational resources is dropped by the first computational node 104a. In an embodiment, the drop of the request indicates that the first computational node 104a may not further process the request. In such a scenario, step 418 may be processed. At step 418, the processor 302 may transmit the request to the next computational node such as the second computational node 104b or third computational node 104c and control of the method passes to end step 430.

At step 420, if the first reliability score is higher than the threshold value of expected reliability, the reliability unit 306 may update the first reliability score associated with the first computational node 104a based on equation 2. For example, the determined first reliability score, “0.90” may be updated such as, “0.9009”, at the first computational node 104a.

At step 422, the processor 302 may update the request for the set of required computational resources to include the first reliability score R₁ of the first computational node 104a along with the threshold value of expected reliability. Further, the processor 302 may update the information pertaining to the one or more required computational resources. As the first computational node 104a has reserved the one or more available computational resources for the request and the rest one or more available computational resources does not fulfill the requirement of the request. Thus the request is updated in such a manner that the updated request include an updated set of required computational resources (set of required computational resources—one or more available computational resources). For example, as shown in Table 1, the request is for the set of required computational resources, such as, “300 MHz CPU” and “5 GB RAM”, and the one or more available computational resources at the first computational node 104a are “100 MHz CPU” and “3 GB RAM”. Thus, the updated request includes the updated set of required computational resources as depicted in Table 3 below:

TABLE 3
Illustration of the updated request transmitted
by the first computational node 104a.

| | | Threshold value | First |
|---|---|---|---|
| Updated | Set of required | of expected | reliability |
| Request | computational resources | reliability | score |
| Request - 1 | 200 MHz CPU, 2 GB RAM | 0.65 | 0.90 |

At step 424, the processor 302 may transmit the updated request for the set of required computational resources to the second computational node 104b among the one or more computational nodes 104.

It will be apparent to a person having ordinary skill in the art that the above Table 3 has been provided only for illustration purposes and should not limit the scope of the invention to these types of updated request only. For example, the set of required computational resources included in the Table 3 may be different from the depicted set of required computational resources and may include more or less computational resources than depicted in Table 3.

At step 426, the first computational node 104a may receive the first notification from the second computational node 104b. In an embodiment, the first notification notifies that the one or more available computational resources available at the second computational node 104b have been allocated to the updated request. In response to the first notification, the first computational node may allocate the one or more available computational resources (100 MHz CPU and 3 GB RAM) to the request. At step 428, the first computational node 104a may transmit the second notification to the computing device 106a. In an embodiment, the second notification includes the instruction to allocate the one or more available computational resources available at the first computational node 104a to process the request. Control passes to end step 430.

FIG. 5 is a flowchart 500 that illustrates another method for the allocation of the set of required computational resources, in accordance with at least one embodiment. For the purpose of ongoing disclosure, the method for computational resource allocation is implemented on the second computational node 104b. However, a person having ordinary skill in the art would understand that the scope of the disclosure is not limited to computational resource allocation by the second computational node 104b. In an embodiment, the method can be implemented on any of the computational node among the one or more computational nodes 104. The flowchart 500 is described in conjunction with FIG. 1, FIG. 2, FIG. 3 and FIG. 4.

The method starts at step 502 and proceeds to step 504. At step 504, the updated request for allocation of the set of required computational resources may be received at the second computational node 104b, from the first computational node 104a among the one or more computational nodes 104. The processor 302 of the second computational node 104b may receive the updated request that comprises the set of required computational resources and the threshold value of expected reliability associated with the set of required computational resources. The updated request may further comprise the first reliability score R₁ of the first computational node 104a. The processor 302 of the second computational node 104b may receive the updated request, as depicted in Table 3.

It will be apparent to a person having ordinary skill in the art that if the updated request may be partially fulfilled at one or more computational nodes 104, then the updated request may comprise a plurality of first reliability scores associated with each of the one or more computational nodes 104.

At step 506, the processor 302 of the second computational node 104b may determine the availability of the set of required computational resources of the updated request. A person skilled in the art would appreciate the updated request comprises an updated set of required computational resources as depicted in Table 3.

The processor 302 may determine the availability of the set of required computational resources of the updated request by matching the set of required computational resources with the one or more available computational resources associated with the second computational node 104b. In an embodiment, the one or more available computational resources available at the second computational node 104b are depicted in below provided Table 4:

TABLE 4
Illustration of one or more available computational resources
available at the second computational node 104b.

| Computing device ID at second | One or more available |
|---|---|
| computational node | computational resources |
| Computing device 2 | 200 MHz CPU, 2 GB RAM |

It will be apparent to a person having ordinary skill in the art that the above Table 4 has been provided only for illustrative purposes and should not limit the scope of the invention to said types of requests. For example, the one or more available computational resources included in the Table 4 may be different from the depicted one or more available computational resources and may include more or less computational resources than depicted in Table 4.

At step 508, the processor 302 may determine, whether the set of required computational resources of the updated request are completely available at the second computational node 104b. The complete availability of the set of the computational resources may indicate that all the required computational resources from the updated request are available with the second computational node 104b. If the processor 302 determines that the set of required computational resources are completely available at the second computational node 104b, the method proceeds to step 510 is performed, else the method proceeds to step 518.

It can be observed from the Table 5, that the processor 302 has the information pertaining to the one or more available computational resources available with the second computational node 104b. For example, the processor 302 maintains the information that the one or more available computational resources (i.e., 200 MHz CPU, 2 GB RAM) are associated with the second computational node 104b.

At step 510, the reliability unit 306 may determine the second reliability score of the second computational node 104b. The reliability unit 306 may determine the second reliability score of the second computational node 104b based on a ratio of number of times a request is completely processed by the second computational node 104b and total number of requests processed by the second computational node 104b. The reliability unit 306 may determine the second reliability score in accordance with the below equation (3).

$${R}_{2} = \frac{{N}_{c}}{{T}_{s}} \qquad ( 3 )$$

where,

R₂=second reliability score at the second computational node 104b, N=number of times a request is completely processed by the second computational node 104b,

Tₛ=total number of requests processed by the second computational node 104b.

For example, the second computational node 104b may receive plurality of requests for computational resource allocation. In an instance, “Tₛ=110” is the total number of requests processed for partial and complete matches by the second computational node 104b. In another instance, “N_{c}=95” is the number of times a request is completely processed by the second computational node 104b. Thus the second reliability score such as, “R₂=0.8636”, may be determined by utilizing the equation (3).

A person skilled in the art will understand that the scope of the disclosure should not be limited to the representation of the determination of the second reliability score using the aforementioned techniques. Further, the examples provided in supra are for illustrative purposes and should not be construed to limit the scope of the disclosure.

At step 512, the reliability unit 306 may determine the third reliability score. The third reliability score may be indicative of a cumulative reliability score of the first computational node 104a and the second computational node 104b. The reliability unit 306 may determine the third reliability score of the of the path of the communication network based on the first reliability score R₁ and the second reliability score R₂. In an embodiment, the reliability unit 306 may retrieve the first reliability score from the updated request. The reliability unit 306 may determine the third reliability score as the product of the first reliability score (R₁) of the first computational node 104a and the second reliability score (R₂) of the second computational node 104b. In an embodiment, the third reliability score may correspond to a level of trust/guarantee score of the path of the communication network to process the request. The path may correspond to a communication network route that connects one or more computational nodes (the first computational node 104a and the second computational node 104b) that together fulfill the requirement of the request. In an embodiment, the reliability unit 306 may determine the third reliability score in accordance with the below equation (4).

R₃=ΠᵢR₁(i)·R₂ (4)

where,

R₃=third reliability score at the second computational node 104b,

R₁=first reliability score of first computational node 104a,

R₂=second reliability score of second computational node 104b,

i=number of computational nodes that together fulfill the requirement of the request.

A person skilled in the art will understand that the scope of the disclosure should not be limited to the representation of the determination of the third reliability score using the aforementioned techniques. Further, the examples provided in supra are for illustrative purposes and should not be construed to limit the scope of the disclosure.

For example, the second computational node 104b may determine the third reliability score based on the first reliability score (R₁)=0.90 of the first computational node 104a and the second reliability score (R₂)=0.8636 of the second computational node 104b. Thus the third reliability score such as, “R₃=0.7772”, may be determined by utilizing the equation (4).

At step 514, the processor 302 may compare the third reliability score R₃ with the threshold value of expected reliability associated with the set of required computational resources of the updated request.

At step 516, the processor 302 may determine whether the third reliability score R₃ is higher than the threshold value of the expected reliability associated with the set of required computational resources of the updated request. If the third reliability score R₃ is higher than the threshold value of the expected reliability associated with the set of required computational resources of the updated request, the method proceeds to step 520 is performed, else the method proceeds to step 518. At step 518, the processor 302 may transmit the updated request to the next computational node such as a third computational node 104c.

At step 520, the reliability unit 306 of the second computational node 104b may update the second reliability score of the second computational node 104b. For example, the determined second reliability score R₂ such as, “0.8636” may be updated such as, “0.8648” at the second computational node 104b.

At step 522, the second computational node 104b may allocate the one or more available computational resources (200 MHz CPU and 2 GB RAM) associated with the second computational node 104b to the received updated request. In an embodiment, when the updated request is received from the computing device 106a that is not connected with the communication network, the second computational node 104b may directly allocate the one or more available computational resources to the computing device 106a.

At step 524, the processor 302 may transmit the first notification to the first computational node 104a that the one or more available computational resources (200 MHz CPU and 2 GB RAM) associated with the second computational node 104b have been allocated to process the updated request. In an embodiment, in response to the first notification received from the second computational node 104b, the first computational node 104a may allocate the one or more available computational resources (100 MHz CPU and 3 GB RAM) associated with the first computational node 104a to process the request. Thus, the first computational node 104a and the second computational node 104b have together allocated the one or more available computational resources to the set of required computational resources (300 MHz CPU and 5 GB RAM) of the request. Control passes to end step 526.

It will be apparent to a person having ordinary skill in the art that similar steps, as discussed in the flowcharts 400 and 500, may be performed by the one or more computational nodes 104, when the request is forwarded to the one or more computational nodes 104 by the processor 302.

In an alternate embodiment, the one or more computational nodes 104 may represent a cloud-computing infrastructure. Further, any of the one or more computational nodes 104 may receive the request from any of the one or more computational nodes 104, as disclosed above. The one or more computing devices 106 may be included in the cloud-computing infrastructure represented by the respective computational nodes 104, or may be external to the cloud-computing network. Further, the request may be accompanied with the requirement of the one or more virtual machines (e.g., to execute one or more applications/workloads). In such a scenario, the one or more virtual machines may be allocated by the one or more computational nodes 104, in accordance with the steps disclosed herein.

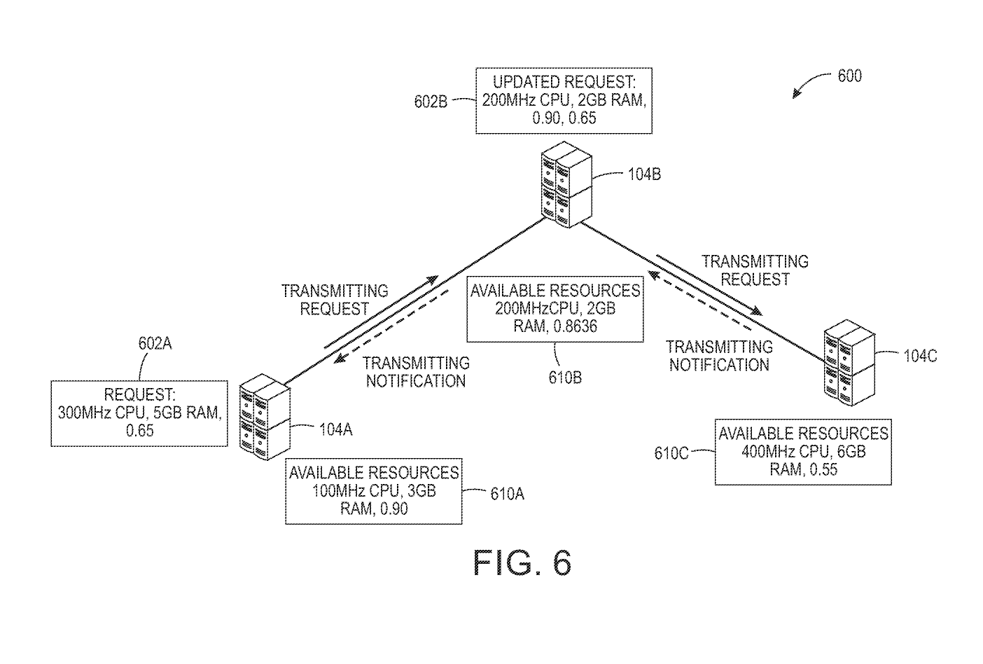

FIG. 6 illustrates block diagram that illustrates an example scenario for the allocation of the set of required computational resources, in accordance with at least one embodiment. The block diagram 600 includes the one or more computational nodes 104, such as 104a, 104b, and 104c. The first computational node 104a may include an available computational resource table 610a. Similarly, the second computational node 104b may include an available computational resource table 610b. Further, the third computational node 104c may include an available computational resource table 610c.

In an embodiment, the first computational node 104a may be configured to receive a request 602a for allocation of a set of required computational resources. Further, the request 602a may comprise the threshold value of expected reliability associated with the set of required computational resources. For example, the request may include a set of required computational resources, such as, “300 MHz CPU” and “5 GB RAM”. Further, the request 602a may include the threshold value of expected reliability, such as, “0.65”, associated with the set of required computational resources.

In an embodiment, the first computational node 104a may be configured to determine the availability of the set of required computational resources to process the request. Further, the first computational node 104a may determine the availability of the set of required computational resources by matching the set of required computational resources with the available computational resource table 610a. As it can be observed from the available computational resource table 610a that the set of required computational resources (300 MHz CPU, 5 GB RAM) of the request 602a are partially matches with the one or more available computational resources (100 MHz CPU, 3 GB RAM) of the available computational resource table 610a.

After determining the availability of the set of required computational resources, the first computational node 104a may be configured to determine the first reliability score of the first computational node 104a. The first reliability score may be determined based on a ratio of number of times the request is partially processed by the first computational node 104a and total number of requests processed by the first computational node 104a. For example, the first reliability score, such as “0.90”, may be determined in accordance with equation (2), as discussed in FIG. 4.

After determining the first reliability score, the first computational node 104a may be configured to compare the first reliability score, “0.90” with the threshold value of expected reliability “0.65” associated with the set of required computational resources of the request 602a. Further, it is observed that the first reliability score, “0.90” is higher than the threshold value of expected reliability “0.65” associated with the set of required computational resources of the request 602a, the first computational node 104a may update the request 602a as an updated request 602b.

The updated request 602b may include the first reliability score, “0.90” of the first computational node 104a along with the threshold value of expected reliability, “0.65”. Further, the updated request 602b may include the updated set of required computational resources, such as, “200 MHz CPU” and “2 GB RAM”. The first computational node 104a may transmit the updated request 602b to the second computational node 104b. Further, the first computational node 104a may update the first reliability score of the first computational node 104a.

Subsequently, the second computational node 104b may receive the updated request 602b from the first computational node 104a. The second computational node 104b may be configured to determine the availability of the set of required computational resources of the updated request 602b, by matching the set of required computational resources of the updated request 602b with the available computational resource table 610b. As it can be observed from the available computational resource table 610b that the set of required computational resources (200 MHz CPU, 2 GB RAM) of the updated request 602b is completely matches with the one or more available computational resources (200 MHz CPU, 2 GB RAM) of the available computational resource table 610b.

After determining the availability of the set of required computational resources of the updated request 602b at the second computational node 104b, the second computational node 104b may be configured to determine the second reliability score of the second computational node 104b. The second reliability score may be determined based on a ratio of number of times the request is completely processed by the second computational node 104b and total number of requests processed by the second computational node 104b. For example, the second reliability score, such as, “0.8636”, may be determined in accordance with equation (3), as discussed in FIG. 5.

After determining the second reliability score, the second computational node 104b may be configured to determine the third reliability score of the path of the communication network. The third reliability score may correspond to the level of trust/guarantee score of the path of the communication network to process the request. The path may correspond to the communication network route that connects one or more computational nodes (the first computational node 104a and the second computational node 104b) that together fulfill the requirement of the request. The third reliability score such as, “0.7772”, may be determined as the product of the first reliability score, “0.90”, and the second reliability score, “0.8636” in accordance with equation (4), as discussed in FIG. 5.

In an embodiment, the second computational node 104b may be configured to compare the third reliability score, “0.7772” with the threshold value of expected reliability “0.65” associated with the set of required computational resources of the updated request 602b. Further, it is observed that the third reliability score, “0.7772” is higher than the threshold value of expected reliability “0.65” associated with the set of required computational resources of the updated request 602b. The second computational node 104b may update the second reliability score, such as, “0.8648”, of the second computational node 104b. Further, the second computational node 104b may be configured to allocate the one or more available computational resources (200 MHz CPU, 2 GB RAM) to the updated request 602b.

In an embodiment, the second computational node 104b may transmit the first notification to the first computational node 104a that the one or more available computational resources (200 MHz CPU, 2 GB RAM) associated with the second computational node 104b have been allocated to process the updated request 602b. Further, in response to the first notification received from the second computational node 104b, the first computational node 104a may allocate the one or more available computational resources (100 MHz CPU, 3 GB RAM) associated with the first computational node 104a to process the request.

After allocation of the one or more available computational resources (100 MHz CPU, 3 GB RAM) available at the first computational node 104a, the first computational node 104a may transmit the second notification to the computing device 106a. The second notification may inform the computing device 106a that one or more available computational resources (100 MHz CPU, 3 GB RAM) associated with the first computational node 104a and the one or more available computational resources (200 MHz CPU, 2 GB RAM) associated with the second computational node 104b have been allocated to process the request for the set of required computational resources (300 MHz CPU, 5 GB RAM).

In an alternate embodiment, the second computational node 104b may drop the updated request 602b, when the third reliability score is lesser than the threshold value of the expected reliability, “0.65”. In such scenario, the second computational node 104b may transmit a third notification to the first computational node 104a that the updated request 602b may not be processed at the second computational node 104b. Further, the second computational node 104b may transmit the updated request to the third computational node 104c. The third computational node 104c may process the updated request in a similar way as the first computational node 104a and the second computational node 104b have processed the request, as discussed herein.

It will be apparent to a person having ordinary skill in the art that similar steps as discussed herein, may be performed by the one or more computational nodes 104, after receiving the request for computational resource allocation.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

To process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

Various embodiments of the methods and systems for allocation of the set of computational resources in a distributed computing environment have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for computational resource allocation in a distributed computing environment, the method comprising:
receiving, by a first computational node, a request for computational resource allocation, wherein the request comprises at least a threshold value of an expected reliability associated with a set of required computational resources;
determining, by the first computational node, an availability of one or more computational resources from the set of required computational resources;
determining, by the first computational node, a first reliability score of the first computational node based on the one or more determined computational resources;
comparing, by the first computational node, the first reliability score with the threshold value; and
transmitting, by the first computational node, the request to a second computational node based on the comparison.

2. A method of claim 1, wherein the request comprises information pertaining to the set of required computational resources.

3. A method of claim 2, further comprising updating, by the first computational node, the information pertaining to the set of required computational resources based on the availability of the one or more computational resources associated with the first computational node.

4. The method of claim 3, further comprising updating, by the first computational node, the request to include the updated information of the set of required computational resources, wherein the updated request is transmitted to the second computational node.

5. A method of claim 1, wherein the set of required computational resources corresponds to at least one of a processing speed, a storage space, a memory space, a software application, a security service, and/or a database service.

6. The method of claim 1, further comprising updating, by the first computational node, the request to include the first reliability score of the first computational node.

7. The method of claim 1, further comprising transmitting, by the first computational node, the request to the second computational node when the first reliability score is higher than the threshold value.

8. The method of claim 1, further comprising dropping, by the first computational node, the request when the first reliability score is lower than the threshold value.

9. The method of claim 1, further comprising receiving, by the first computational node, a notification from the second computational node, wherein the first computational node allocates the one or more computational resources to the request in reception of the notification.

10. A method for computational resource allocation in a distributed computing environment, the method comprising:
receiving, by a first computational node, a request for computational resource allocation, wherein the request comprising at least a threshold value of an expected reliability associated with a set of required computational resources, and a first reliability score of a second computational node, wherein the request is received from the second computational node;
determining, by the first computational node, an availability of the set of required computational resources;
determining, by the first computational node, a second reliability score of the first computational node based on the determined set of required computational resources;
determining, by the first computational node, a third reliability score based on the first reliability score and the second reliability score;
comparing, by the first computational node, the third reliability score with the threshold value; and
allocating, by the first computational node, the set of required computational resources to process the request, based on the comparison.

11. The method of claim 10, wherein the third reliability score corresponds to a cumulative reliability score of the first computational node and the second computational node.

12. The method of claim 10, further comprising allocating, by the first computational node, the set of required computational resources to process the request when the third reliability score is higher than the threshold value.

13. The method of claim 10, further comprising transmitting, by the first computational node, the request to a third computational node when the third reliability score is lower than the threshold value.

14. The method of claim 10, further comprising transmitting, by the first computational node, a notification to the second computational node, wherein the first computational node allocates the set of required computational resources to the request on transmission of the notification.

15. A system for computational resource allocation in a distributed computing environment, the system comprising:
one or more processors of a first computational node configured to:
receive a request for computational resource allocation, wherein the request comprises at least a threshold value of an expected reliability associated with a set of required computational resources;
determine an availability of one or more computational resources from the set of required computational resources;
determine a first reliability score of the first computational node based on the one or more determined computational resources;
compare the first reliability score with the threshold value; and
transmit the request to a second computational node based on the comparison.

16. The system of claim 15, wherein the request comprises information pertaining to the set of required computational resources.

17. The system of claim 16, wherein the one or more processors of the first computational node are further configured to update, the information pertaining to the set of required computational resources based on the availability of the one or more computational resources associated with the first computational node.

18. The system of claim 17, wherein the one or more processors of the first computational node are further configured to update the request to include the updated information of the set of required computational resources, wherein the updated request is transmitted to the second computational node.

19. A system of claim 15, wherein the set of required computational resources correspond to at least one of a processing speed, a storage space, a memory space, a software application, a security service, and/or a database service.

20. The system of claim 15, wherein the one or more processors of the first computational node are further configured to update the request to include the first reliability score of the first computational node.

21. The system of claim 15, wherein a transceiver of the first computational node is further configured to configured to transmit the updated request to the second computational node when the first reliability score is higher than the threshold value.

22. The system of claim 21, wherein the transceiver of the first computational node is further configured to receive a notification from the second computational node, wherein the one or more processors of the first computational node are configured to allocate the one or more computational resources to the request on reception of the notification.

23. The system of claim 15, wherein the one or more processors of the first computational node are further configured to drop the request when the first reliability score is lower than the threshold value.

24. A system for computational resource allocation in a distributed computing environment, the system comprising:
one or more processors of a first computational node configured to:
receive a request for computational resource allocation, wherein the request comprising at least a threshold value of an expected reliability associated with a set of required computational resources, and a first reliability score of a second computational node, wherein the request is received from the second computational node;
determine an availability of the set of required computational resources;
determine a second reliability score of the first computational node based on the determined set of required computational resources;
determine a third reliability score based on the first reliability score and the second reliability score;
compare the third reliability score with the threshold value; and
allocate the set of required computational resources to process the request, based on the comparison.

25. The system of claim 24, wherein the third reliability score corresponds to a cumulative reliability score of the first computational node and the second computational node.

26. The system of claim 24, wherein the one or more processors of the first computational node are further configured to allocate the set of required computational resources to process the request when the third reliability score is higher than the threshold value.

27. The system of claim 24, further comprising a transceiver configured to transmit the request to a third computational node when the third reliability score is lower than the threshold value.

28. The system of claim 27, wherein the transceiver is further configured to transmit, from the first computational node, a notification to the second computational node, wherein the one or more processors of the first computational node are configured to allocate the set of required computational resources to the request on transmission of the notification.

29. A non-transitory computer-readable storage medium having stored thereon, a set of computer-executable instructions for causing a computer comprising one or more processors to perform steps comprising:
receiving, by a first computational node, a request for computational resource allocation, wherein the request comprising at least a threshold value of an expected reliability associated with a set of required computational resources;
determining, by the first computational node, an availability of one or more computational resources from the set of required computational resources;
determining, by the first computational node, a first reliability score of a first computational node based on the one or more determined computational resources;
comparing, by the first computational node, the first reliability score with the threshold value; and
transmitting, by the first computational node, the request to a second computational node based on the comparison.

30. A non-transitory computer-readable storage medium having stored thereon, a set of computer-executable instructions for causing a computer comprising one or more processors to perform steps comprising:
receiving, by a first computational node, a request for computational resource allocation, wherein the request comprising at least a threshold value of an expected reliability associated with a set of required computational resources, and a first reliability score of a second computational node, wherein the request is received from the second computational node;
determining, by the first computational node, an availability of the set of required computational resources;
determining, by the first computational node, a second reliability score of a first computational node based on the determined set of required computational resources;
determining, by the first computational node, a third reliability score based on the first reliability score and the second reliability score;
comparing, by the first computational node, the third reliability score with the threshold value; and
allocating, by the first computational node, the set of required computational resources to process the request, based on the comparison.
